(19) United States
(12) Patent Application Publication
(10) Pub. No.: US 2006/0040676 A1
(43) Pub. Date: Feb. 23, 2006

(54) Mobile terminal capable of generating a location information signal that indicates a landmark closest to the mobile terminal

(75) Inventor: Chi-Ting Chen, Taipei Hsien (TW)

Correspondence Address: OSTROLENK FABER GERB & SOFFEN, 1180 AVENUE OF THE AMERICAS, NEW YORK, NY, 100368403, US

(73) Assignee: Wintecronics Co., Ltd.

(21) Appl. No.: 10/996,528

(22) Filed: Nov. 24, 2004

(30) Foreign Application Priority Data
Aug. 18, 2004 (TW) 093124803

(51) Int. Cl. H04M 11/04; H04Q 7/20

(52) U.S. Cl. 455/456.1; 455/404.2; 455/461

(57) ABSTRACT

A tracking method, which is implemented using a mobile terminal, includes the steps of establishing in the mobile terminal a landmark database that contains location data of a plurality of predetermined landmarks, enabling the mobile terminal to periodically receive a position information signal that contains position information of the mobile terminal, and enabling the mobile terminal to generate a location information signal that is subsequently transmitted to a locating party through a wireless telecommunications network. The location information signal is generated with reference to the landmark database, and the position information of the position information signal received by the mobile terminal, and indicates one of the landmarks in the landmark database that is closest to the mobile terminal.

### BACKGROUND OF THE INVENTION

1. Field of the Invention

The invention relates to a mobile terminal, more particularly to a mobile terminal that is capable of generating a location information signal, which indicates a landmark closest to the mobile terminal.

2. Description of the Related Art

The global positioning system (GPS) is employed to assist a locating party in acquiring the location of a conventional mobile terminal.

In operation, the conventional mobile terminal periodically receives a position information signal from the GPS. The position information signal contains position information of the conventional mobile terminal. The mobile terminal, based on the position information, generates a location information signal that is subsequently transmitted to the locating party through a wireless telecommunications network. The location information signal indicates the longitude and latitude coordinate data of the conventional mobile terminal.

The conventional mobile terminal is disadvantageous in that it transmits the longitude and latitude coordinate data in a short message service (SMS) format. The longitude and latitude coordinate data contained in the SMS may be unintelligible for an average person, and requires the use of a map, which arises in inconvenience.

### SUMMARY OF THE INVENTION

Therefore, the object of the present invention is to provide a tracking method that is implemented using a mobile terminal and that is capable of overcoming the aforesaid drawbacks of the prior art.

According to one aspect of the present invention, a tracking method comprises the steps of:
(A) establishing in a mobile terminal a landmark database that contains location data of a plurality of predetermined landmarks;
(B) enabling the mobile terminal to periodically receive a position information signal that contains position information of the mobile terminal; and
(C) enabling the mobile terminal to generate a location information signal that is subsequently transmitted to a locating party through a wireless telecommunications network, the location information signal being generated with reference to the landmark database and the position information of the position information signal received in step (B), and indicating one of the landmarks in the landmark database that is closest to the mobile terminal.

According to another aspect of the present invention, a mobile terminal comprises a telecommunications unit and positioning unit. The positioning unit is coupled to the telecommunications unit, and includes a signal receiver module, a memory module, and a processormodule. The signal receiver module is operable so as to periodically receive a position information signal that contains position information of the mobile terminal. The memory module serves to store a landmark database that contains location data of a plurality of predetermined landmarks. The processor module is coupled to the signal receiver module and the memory module, and is operable so as to generate a location information signal that is subsequently transmitted by the telecommunications unit to the locating party through a wireless telecommunications network. The location information signal is generated with reference to the landmark database stored in the memory module, and the position information of the position information signal received by the signal receiver module, and indicates one of the landmarks in the landmark database that is closest to the mobile terminal.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram of the preferred embodiment of a mobile terminal according to the present invention;

FIG. 2 is a schematic view to illustrate the preferred embodiment when applied in acquiring the location of a vehicle; and

FIGS. 3 and 4 are flowcharts of the preferred embodiment of a tracking method according to the present invention.

### DETAILED DESCRIPTION OF THE PREFERRED EMBODIMENT

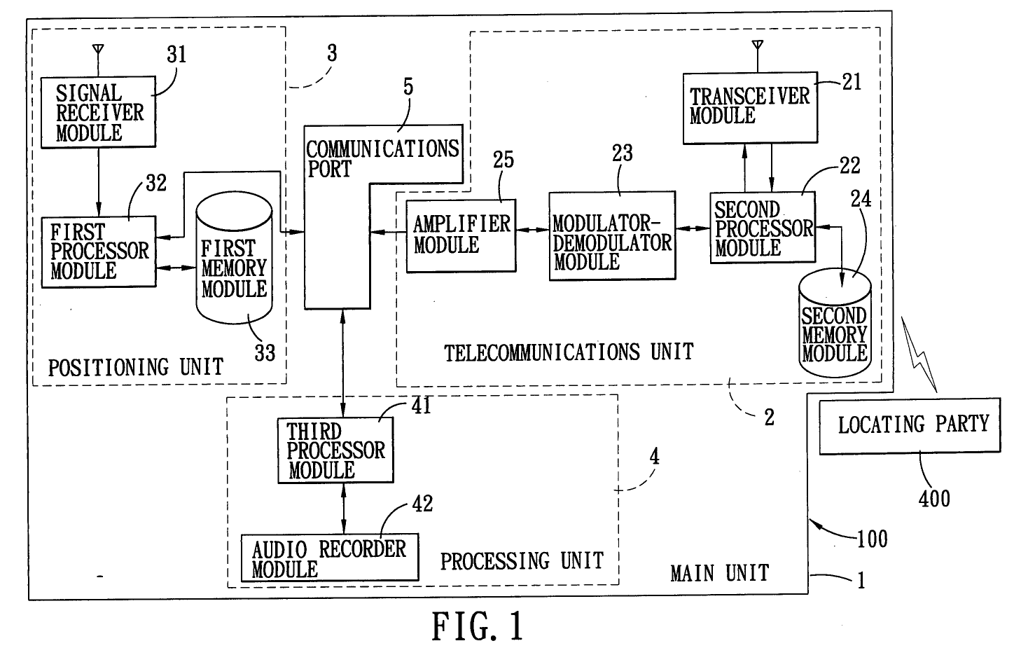

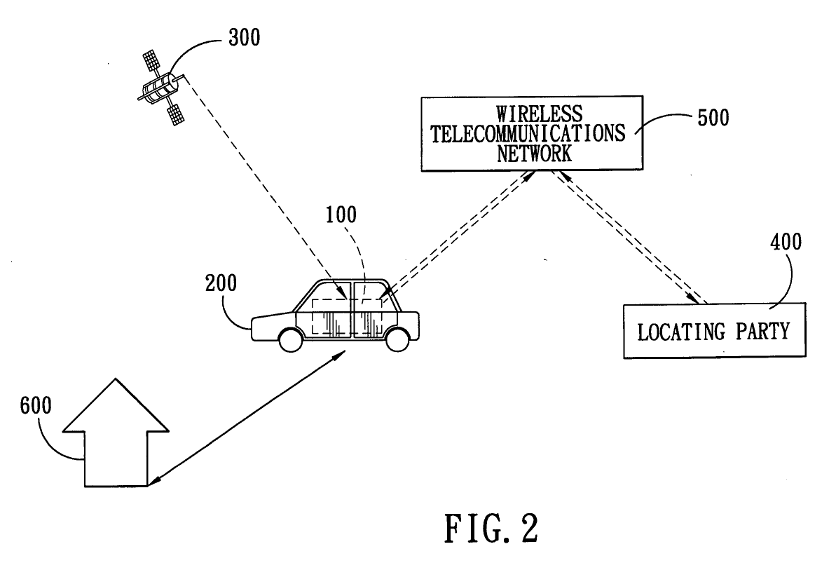

Referring to FIGS. 1 and 2, the preferred embodiment of a mobile terminal 100 according to this invention is shown to include a telecommunications unit 2 and a positioning unit 3.

In this embodiment, the mobile terminal 100 is applied to facilitate a locating party 400 in obtaining the location of a vehicle 200. In an alternative embodiment, the mobile terminal 100 is applied to facilitate the locating party 400 in obtaining the location of a person (not shown) or an animal (not shown).

The positioning unit 3 is coupled to the telecommunications unit 2, and includes a signal receiver module 31, a first memory module 33, and a first processor module 32.

The signal receiver module 31 is operable so as to periodically receive a position information signal that contains position information of the mobile terminal 100.

In this embodiment, the signal receiver module 31 of the positioning unit 3 receives the position information signal from a global positioning system (GPS) service provider 300. Moreover, the position information signal received by the signal receiver module 31 of the positioning unit 3 includes a time stamp that indicates the time when the position information of the mobile terminal 100 was obtained.

The first memory module 33 serves to store a landmark database that contains location data of a plurality of predetermined landmarks 600.

The first processor module 32 is coupled to the signal receiver module 31 and the first memory module 33, and is operable so as to generate a location information signal that is subsequently transmitted by the telecommunications unit 2 to the locating party 400 through a wireless telecommunications network 500.

It is noted that the location information signal is generated with reference to the landmark database stored in the first memory module 33, and the position information of the position information signal received by the signal receiver module 31. In this embodiment, the location information signal may be in a short message service (SMS) or multi-media service (MMS) format, and indicates one of the landmarks 600 in the landmark database that is closest to the mobile terminal 100. Preferably, the location information signal generated by the first processor module 33 contains the name of the closest landmark 600, the relative direction between the mobile terminal 100 and the closest landmark 600, the distance between the mobile terminal 100 and the closest landmark 600, and coordinate data of the closest landmark 600.

In this embodiment, the first processor module 32 is configured to store the position information of a latest position information signal received by the signal receiver module 31 in the first memory module 33. The position information referred to by the first processor module 32 when generating the location information signal is that contained in the latest position information signal received by the signal receiver module 31 of the positioning unit 3 when signal quality of the latest position information signal is good, and is that stored in the first memory module 33 of the positioning unit 3 when the signal quality of the latest position information signal is poor.

Preferably, the first processor module 32 of the positioning unit 3 generates the location information signal in response to a location request issued by the locating party 400, in a manner that will be described in greater detail hereinbelow.

The telecommunications unit 2 conforms to a global system for mobile communications (GSM) standard, and includes a transceiver module 21, a second memory module 24, a modulator-demodulator module 23, and a second processor module 22.

The transceiver module 21 is operable so as to transmit the location information signal to the locating party 400 through the wireless telecommunications network 500, and so as to receive the location request issued by the locating party 400 through the wireless telecommunications network 500.

The second memory module 24 stores an identification number of the locating party 400. The transceiver module 21 of the telecommunications unit 2 transmits the location information signal to the locating party 400 using the identification number of the locating party 400 that was stored in the second memory module 24.

The second memory module 24 further stores a program that converts the location information signal into the SMS or MMS format.

The second memory module 24 may further store identification numbers, each of which corresponds to a location information receiving party (not shown). In this case, the transceiver module 21 of the telecommunications unit 2 further transmits the location information signal to the location information receiving parties using the identification numbers of the location information receiving parties that were stored in the second memory module 24.

The modulator-demodulator module 23 is operable so as to modulate the location information signal prior to transmission of the transceiver module 21, and so as to demodulate the location request received by the transceiver module 21.

The second processor module 22 is coupled to and controls operations of the transceiver module 21, the second memory module 24, and the modulator-demodulator module 23.

The telecommunications unit 2 further includes an amplifier module 25 coupled to the modulator-demodulator module 23, and operable so as to amplify the location request demodulated by the modulator-demodulator module 23.

The mobile terminal 100 further includes a processing unit 4 that is coupled to the telecommunications unit 2 and the positioning unit 4, and that includes a third processor module 41 operable so as to verify the location request that was transmitted by the locating party 400 through the wireless telecommunications network 500. The first processor module 32 of the positioning unit 3 generates the location information signal only upon successful verification of the location request by the third processor module 41.

The processing unit 4 further includes an audio recorder module 42 coupled to and controlled by the third processor module 41 so as to record voice messages. The mobile terminal 100 further includes a communications port 5 that interconnects the telecommunications unit 2, the positioning unit 3, and the processing unit 4. In this embodiment, the communications port 5 conforms to that RS-232 serial interface standard.

Preferably, the mobile terminal 100 further includes an infrared device (not shown) coupled to the positioning unit 3.

It is noted that the landmark database stored in the first memory module 33 of the positioning unit 3 may be updated with a SMS received by the transceiver module 21 of the telecommunications unit 2 through the wireless telecommunications network 500, or with a file downloaded from a website in the internet through the RS-232 serial interface 5 or the infrared device.

The mobile terminal 100 further includes a main unit 1. The telecommunications unit 2, the positioning unit 3, the processing unit 4, the communications port 5, and the infrared device are housed within the main unit 1.

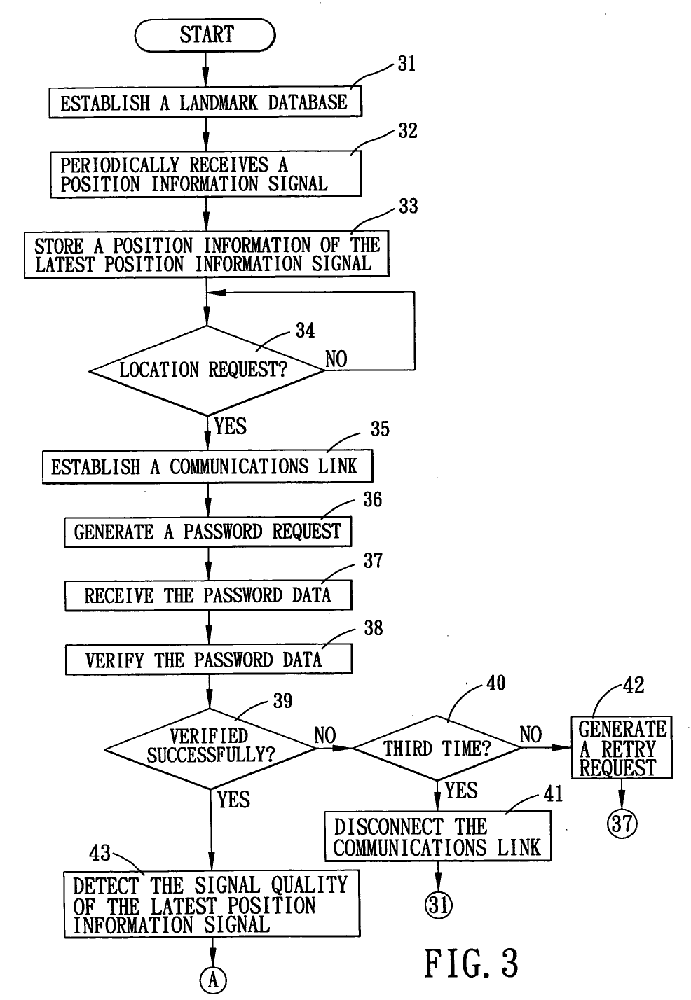

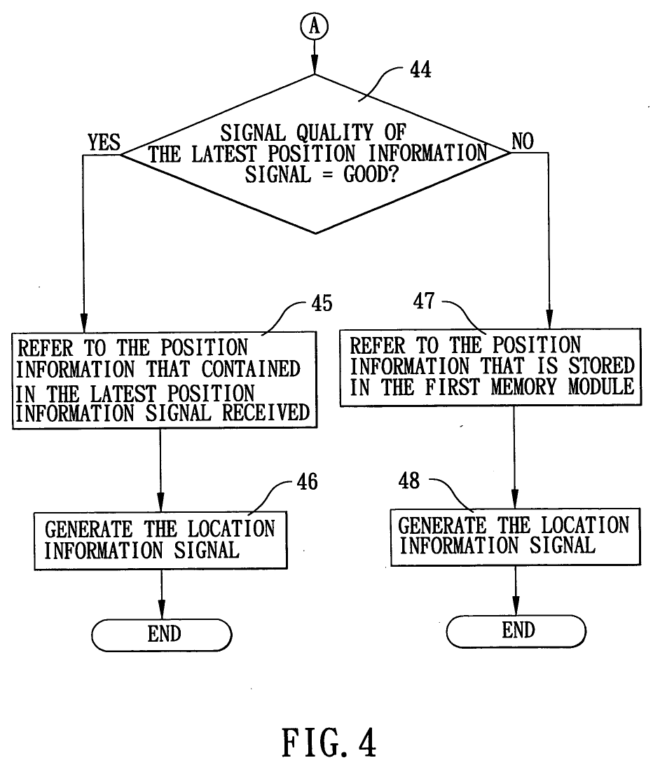

The preferred embodiment of a tracking method implemented using the mobile terminal 100 of this invention includes the steps shown in FIGS. 3 and 4:

In step 31, the landmark database is established in the first memory module 33 of the positioning unit 3 of the mobile terminal 100.

In step 32, the signal receiver module 31 of the positioning unit 3 of the mobile terminal 100 periodically receives the position information signal.

In step 33, the position information of the latest position information signal received by the signal receiver module 31 of the positioning unit 3 of the mobile terminal 100 is stored in the first memory module 33 of the positioning unit 3 of the mobile terminal 100.

In step 34, if the transceiver module 21 of the telecommunications unit 2 of the mobile terminal 100 receives a location request issued by the locating party 400 through the wireless telecommunications network 500, the flow proceeds to step 35. Otherwise, the flow goes back to step 32.

In step 35, the transceiver module 21 of the telecommunications unit 2 of the mobile terminal 100 establishes a communications link with the locating party 400 through the wireless telecommunication network 500.

In step 36, the third processor module 41 of the processing unit 4 of the mobile terminal 100 generates a password request signal that is subsequently transmitted by the transceiver module 21 of the telecommunications unit 2 of the mobile terminal 100 to the locating party 400 through the wireless telecommunications network 500. It is noted that the password request signal is preferably in a voice message format, and includes a first pre-recorded voice message that was recorded using the audio recorder module 42 of the processing unit 4 and that instructs the locating party 400 to enter password data.

In step 37, the transceiver module 21 of the telecommunications unit 2 of the mobile terminal 100 receives the password data from the locating party 400.

In step 38, the third processor module 41 of the processing unit 4 of the mobile terminal 100 verifies the password data transmitted by the locating party 400 through the wireless telecommunications network 500.

In step 39, if the third processor module 41 of the processing unit 4 of the mobile terminal 100 successfully verified the password data received from the locating party 400, the flow proceeds to step 43. Otherwise, the flow proceeds to step 40.

In step 40, the third processor module 41 of the processing unit 4 of the mobile terminal 100 checks whether the password data has been verified for the third time. If yes, the flow proceeds to step 41. Otherwise, the flow proceeds to step 42.

In step 41, the transceiver module 21 of the telecommunications unit 2 of the mobile terminal 100 disconnects the communications link with the locating party 400. Thereafter, the flow goes back step 32.

In step 42, the third processor module 41 of the processing unit 4 of the mobile terminal 100 generates a retry request that is subsequently transmitted by the transceiver module 21 of the telecommunications unit 2 to the locating party 400 through the wireless telecommunications network 500. Thereafter, the flow goes back to step 37.

It is noted that the retry request is also preferably in a voice message format, and includes a second pre-recorded voice message that was recorded using the audio recorder module 42 of the processing unit 4 and that instructs the locating party 400 to re-enter the password data.

In step 43, the signal receiver module 31 of the positioning unit 3 of the mobile terminal 100 detects the signal quality of the latest position information signal.

In step 44, if the signal quality of the latest position information signal is good, the flow proceeds to step 45. If the signal quality of the latest position information signal is poor, the flow proceeds to step 47.

In step 45, the first processor module 32 of the positioning unit 3 of the mobile terminal 100 refers to the position information contained in the latest position information signal received by the signal receiver module 31 of the positioning unit 3 of the mobile terminal 100.

In step 46, the first processor module 32 of the positioning unit 3 of the mobile terminal 100 generates the location information signal that is subsequently transmitted by the transceiver module 21 of the telecommunications unit 2 of the mobile terminal 100 to the locating party 400 through the wireless telecommunications network 500.

In step 47, the first processor module 32 of the positioning unit 3 of the mobile terminal 100 refers to the position information that is stored in the first memory module 33 of the positioning unit 3 of the mobile terminal 100.

In step 48, the first processor module 32 of the positioning unit 3 of the mobile terminal 100 generates the location information signal that is subsequently transmitted by the transceiver module 21 of the telecommunications unit 2 of the mobile terminal 100 to the locating party 400 through the wireless telecommunications network 500.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A tracking method comprising the steps of:
(A) establishing in a mobile terminal a landmark database that contains location data of a plurality of predetermined landmarks;
(B) enabling the mobile terminal to periodically receive a position information signal that contains position information of the mobile terminal; and
(C) enabling the mobile terminal to generate a location information signal that is subsequently transmitted to a locating party through a wireless telecommunications network, the location information signal being generated with reference to the landmark database and the position information of the position information signal received in step (B), and indicating one of the landmarks in the landmark database that is closest to the mobile terminal.

2. The tracking method as claimed in claim 1, wherein the position information signal received by the mobile terminal in step (B) includes a time stamp that indicates the time when the position information of the mobile terminal was obtained.

3. The tracking method as claimed in claim 1, wherein step (B) includes enabling the mobile terminal to store the position information of a latest position information signal received by the mobile terminal.

4. The tracking method as claimed in claim 3, wherein, in step (C), the position information referred to by the mobile terminal when generating the location information signal is that contained in the latest position information signal received by the mobile terminal when signal quality of the latest position information signal is good, and is that stored in the mobile terminal when the signal quality of the latest position information signal is poor.

5. The tracking method as claimed in claim 1, wherein, in step (C), the mobile terminal generates the location information signal in response to a location request issued by the locating party and received by the mobile terminal through the wireless telecommunications network.

6. The tracking method as claimed in claim 5, wherein step (C) includes:
(C1) upon receipt of the location request, enabling the mobile terminal to generate a password request signal that is transmitted to the locating party through the wireless telecommunications network;
(C2) enabling the mobile terminal to receive password data transmitted by the locating party through the wireless telecommunications network; and
(C3) enabling the mobile terminal to verify the password data received from the locating party such that the mobile terminal generates the location information signal only upon successful verification of the password data.

7. The tracking method as claimed in claim 6, wherein the password request signal is in a voice message format.

8. The tracking method as claimed in claim 1, wherein, in step (B), the mobile terminal receives the position information signal from a global positioning system (GPS) service provider.

9. The tracking method as claimed in claim 1, wherein the location information signal generated by the mobile terminal contains at least one of the name of the closest landmark, the relative direction between the mobile terminal and the closest landmark, the distance between the mobile terminal and the closest landmark, and coordinate data of the closest landmark.

10. The tracking method as claimed in claim 1, wherein the location information signal is in one of a short message service (SMS) format and a multimedia message service (MMS) format.

11. A mobile terminal comprising:
a telecommunications unit; and
a positioning unit coupled to said telecommunications unit, and including
a signal receiver module operable so as to periodically receive a position information signal that contains position information of said mobile terminal,
a first memory module for storing a landmark database that contains location data of a plurality of predetermined landmarks, and
a first processor module coupled to said signal receiver module and said first memory module, and operable so as to generate a location information signal that is subsequently transmitted by said telecommunications unit to the locating party through a wireless telecommunications network, said location information signal being generated with reference to said landmark database stored in said memory module, and the position information of the position information signal received by said signal receiver module, and indicating one of the landmarks in said landmark database that is closest to said mobile terminal.

12. The mobile terminal as claimed in claim 11, wherein said first processor module is configured to store the position information of a latest position information signal received by said signal receiver module in said first memory module.

13. The mobile terminal as claimed in claim 12, wherein the position information referred to by said first processor module when generating the location information signal is that contained in the latest position information signal received by said signal receiver module when signal quality of the latest position information signal is good, and is that stored in said first memory module when the signal quality of the latest position information signal is poor.

14. The mobile terminal as claimed in claim 11, wherein said telecommunications unit conforms to a global system for mobile communications (GSM) standard, and includes a transceiver module operable so as to transmit the location information signal to the locating party through the wireless telecommunications network.

15. The mobile terminal as claimed in claim 14, wherein said telecommunications unit further includes a second memory module for storing an identification number of the locating party, said transceiver module of said telecommunications unit transmitting the location information signal to the locating party using the identification number of the locating party that was stored in said second memory module.

16. The mobile terminal as claimed in claim 14, wherein said first processor module generates the location information signal in response to a location request issued by the locating party and received by said transceiver module of said telecommunications unit through the wireless telecommunications network.

17. The mobile terminal as claimed in claim 16, further including a processing unit coupled to said positioning unit and said telecommunications unit, and operable so as to verify the location request that was transmitted by the locating party through the wireless telecommunications network, said first process or module of said positioning unit generating the location information signal only upon successful verification of the location request by said processing unit.

18. The mobile terminal as claimed in claim 11, wherein said signal receiver module of said positioning unit is adapted for receiving the position information signal from a global positioning system (GPS) service provider.

19. The mobile terminal as claimed in claim 11, wherein the location information signal generated by said first processor module of said positioning unit contains at least one of the name of the closest landmark, the relative direction between said mobile terminal and the closest landmark, the distance between said mobile terminal and the closest landmark, and coordinate data of the closest landmark.

20. The mobile terminal as claimed in claim 11, wherein the location information signal is in one of a short message service (SMS) format and a multimedia message service (MMS) format.
